(19) United States
(12) Patent Application Publication
(10) Pub. No.: US 2026/0054118 A1
(43) Pub. Date: Feb. 26, 2026

(54) MONITORING SYSTEM FOR AT LEAST ONE SPRINKLER PIPE AND OPERATION METHOD THEREFOR

(71) Applicant: HANBIT SAFETY ENGINEERING CO., LTD., Seoul (KR)

(72) Inventors: Yong Sun CHO, Seoul (KR); Dong Min Kim, Seoul (KR); Kyeong Sik Park, Seoul (KR); Eun Seong Go, Seoul (KR); Ki Won Byun, Seoul (KR)

(21) Appl. No.: 19/374,028

(22) Filed: Oct. 30, 2025

Related U.S. Application Data
(63) Continuation of application No. PCT/KR2023/015532, filed on Oct. 10, 2023.

(30) Foreign Application Priority Data
Aug. 30, 2023 (KR) 10-2023-0114594

(51) Int. Cl. A62C 37/50; A62C 35/60; A62C 35/68

(52) U.S. Cl. CPC A62C 37/50; A62C 35/60; A62C 35/68

(57) ABSTRACT

An operation method for a monitoring system for a sprinkler pipe, according to one embodiment of the present invention, comprises the steps of: receiving, from a plurality of composite sensor devices, a plurality of pieces of identification information indicating the plurality of composite sensor devices associated with a plurality of installation locations and a plurality of pieces of pipe state information measured by means of the plurality of composite sensor devices, wherein each of the plurality of pieces of pipe condition information includes a pH measurement value and an internal pressure value for a pipe section associated with each installation location; detecting a pH abnormality for the at least one sprinkler pipe on the basis of each of the pH measurement values and each of the pH measurement values; and transmitting, to an automatic distribution device, a control signal instructing injection of an environmentally friendly corrosion inhibitor into at least one pipe section in which the pH abnormality is detected, when it is determined that at least one pH value exceeds a preset first threshold range on the basis of each of the pH measurement values and each of the pH measurement values.

### CROSS-REFERENCE TO RELATED APPLICATIONS

This application is a Continuation of Application No. PCT/KR2023/015532, filed on Oct. 10, 2023, which in turn claims the benefit of Korean Patent Application No. 10-2023-0114594, filed on Aug. 30, 2023. The entire disclosures of all these applications are hereby incorporated by reference.

### TECHNICAL FIELD

The present specification relates to a monitoring system for at least one sprinkler pipe and an operation method therefor, and more specifically, to a monitoring system and an operation method therefor, in which the monitoring system may perform automatic distribution of eco-friendly corrosion inhibitors depending on a pH state of at least one sprinkler pipe detected using a plurality of composite sensor devices and may generate an alarm signal for pipe replacement and position detection of an aging pipe depending on an internal pressure state of the pipe.

### BACKGROUND ART

Corrosion may be prevented by removing one element of the corrosion triangle where water, air, and metal meet. There are various implementation types of sprinklers such as a dry sprinkler, a wet sprinkler, a pre-action sprinkler, a deluge sprinkler, and a negative pressure sprinkler, and each type differs in terms of installation, operation principle, and maintenance.

For example, the wet sprinkler is a type in which water is constantly filled in a pipe and water is sprayed when a head thereof is ruptured by heat during a fire. In addition, the negative pressure sprinkler is a type in which water and air are filled together in a pipe, and water is sprayed as the air is released during a fire.

On the other hand, the pre-action sprinkler is a type in which there is no water in a pipe as the pre-action sprinkler interworks with a fire detector, but water is supplied through the pipe when a fire is detected. In addition, the deluge sprinkler is a type in which there is no water in the pipe at normal times, but all heads thereof operate at the same time when a fire is detected.

As a conventional proposal, Korean Registered Patent No. 10-2101625, which describes an “ICT integrated monitoring water management system for constructing a smart water city”, may be referred to.

### DISCLOSURE

### Technical Problem

An object of the present specification is to provide a monitoring system and an operation method therefor, in which the monitoring system may perform automatic distribution of eco-friendly corrosion inhibitors depending on a pH state of at least one sprinkler pipe detected using a plurality of composite sensor devices and may generate an alarm signal for pipe replacement and position detection of an aging pipe depending on an internal pressure state of the pipe.

The technical problem to be achieved by the present specification is not limited to the technical problem described above, and other technical problems not described will be clearly understood by those skilled in the art to which the present specification pertains from the following description.

### Technical Solution

According to one embodiment, an operation method for a monitoring system for at least one sprinkler pipe, includes: receiving, from a first composite sensor device, first identification information indicating the first composite sensor device associated with a first installation position and first pipe state information measured by the first composite sensor device, in which the first pipe state information includes a first pH measurement value and a first internal pressure value for a first pipe section associated with the first installation position; receiving, from a second composite sensor device, second identification information indicating the second composite sensor device associated with a second installation position and second pipe state information measured by the second composite sensor device, in which the second pipe state information includes a second pH measurement value and a second internal pressure value for a second pipe section associated with the second installation position; detecting a pH abnormality for the at least one sprinkler pipe based on the first pH measurement value and the second pH measurement value; and transmitting, to an automatic distribution device, a control signal indicating injection of an eco-friendly corrosion inhibitor into at least one pipe section in which the pH abnormality is detected, when it is determined that at least one pH value is out of a preset first threshold range based on the first pH measurement value and the second pH measurement value.

According to one embodiment, the eco-friendly corrosion inhibitor may correspond to a silicate-based corrosion inhibitor, and the at least one pipe section may be determined based on the first identification information and the second identification information.

According to one embodiment, the method may further include detecting pipe aging for the at least one sprinkler pipe based on the first internal pressure value and the second internal pressure value, when it is determined that the at least one pH value is not out of the first threshold range.

According to one embodiment, the method may further include generating replacement alarm information about at least one of the first and second pipe sections, in which aging is detected, when it is determined that at least one internal pressure value is out of a preset second threshold range based on the first internal pressure value and the second internal pressure value.

According to one embodiment, a monitoring system for at least one sprinkler pipe, includes: a plurality of composite sensor devices associated with a plurality of installation positions of the at least one sprinkler pipe, respectively;
at least one relay device configured to individually receive a plurality of pipe state information and a plurality of identification information from the plurality of composite sensor devices; an automatic distribution device configured to store and supply an eco-friendly corrosion inhibitor; and an integrated control server configured to interwork with the at least one relay device and the automatic distribution device through a pre-established network, in which the integrated control server is configured to: detect a pH abnormality for the at least one sprinkler pipe based on a plurality of pH measurement values included in the plurality of pipe state information; and transmit, to the automatic distribution device, a control signal indicating injection of the eco-friendly corrosion inhibitor into at least one pipe section, in which the pH abnormality is detected, when it is determined that at least one pH value is out of a preset first threshold range based on the plurality of pH measurement values.

### Advantageous Effects

According to one embodiment of the present specification, it is possible to provide a monitoring system and an operation method therefor, in which the monitoring system may perform automatic distribution of eco-friendly corrosion inhibitors depending on a pH state of at least one sprinkler pipe detected using a plurality of composite sensor devices and may generate an alarm signal for pipe replacement and position detection of an aging pipe depending on an internal pressure state of the pipe.

### DESCRIPTION OF DRAWINGS

FIG. 1 exemplarily shows at least one sprinkler pipe to which a monitoring system is applied according to one embodiment.

FIG. 2 shows a conceptual diagram for an eco-friendly corrosion inhibitor injected into the at least one sprinkler pipe according to one embodiment.

FIG. 3 shows a block diagram of the monitoring system for the at least one sprinkler pipe according to one embodiment.

FIG. 4 shows a block diagram of a composite sensor device according to one embodiment.

FIG. 5 shows a block diagram for a relay device according to one embodiment.

FIG. 6 is an exemplary diagram of a cable loop circuit applied to the monitoring system for the at least one sprinkler pipe according to one embodiment.

FIG. 7 is an exemplary diagram of an inspection circuit applied to the monitoring system for the at least one sprinkler pipe according to one embodiment.

FIG. 8 is a flowchart related to an operation method of the monitoring system for the at least one sprinkler pipe according to one embodiment.

FIG. 9 is a block diagram for exemplarily explaining a computing environment including a computing device suitable for use in an exemplary embodiment.

### MODE FOR INVENTION

All of the above-described features and the following detailed description are exemplary matters for helping the description and understanding of the present specification. That is, the present specification is not limited to such an embodiment and may be embodied in other forms. The following embodiments are merely illustrative for fully disclosing the present specification and are intended to convey the present specification to those skilled in the art to which the present specification pertains. Accordingly, when there are several methods for implementing the components of the present specification, it is necessary to clarify that the implementation of the present specification is possible with any of these methods, which are specific or have the same identity.

In the present specification, when there is a mention that a certain configuration includes specific elements, or when there is a mention that a certain process includes specific steps, it means that other elements or other steps may be further included. That is, the terms used in the present specification are only for describing specific embodiments, and are not intended to limit the concept of the present specification. Furthermore, examples described to help understanding of the present invention include complementary embodiments thereof.

The terms used in the present specification have meanings that those skilled in the art to which the present specification pertains generally understand. The terms commonly used should be interpreted in a consistent sense according to the context of the present specification. In addition, the terms used in the present specification should not be interpreted in an excessively ideal or formal sense unless the meaning is clearly defined. Hereinafter, embodiments of the present specification will be described with reference to the accompanying drawings.

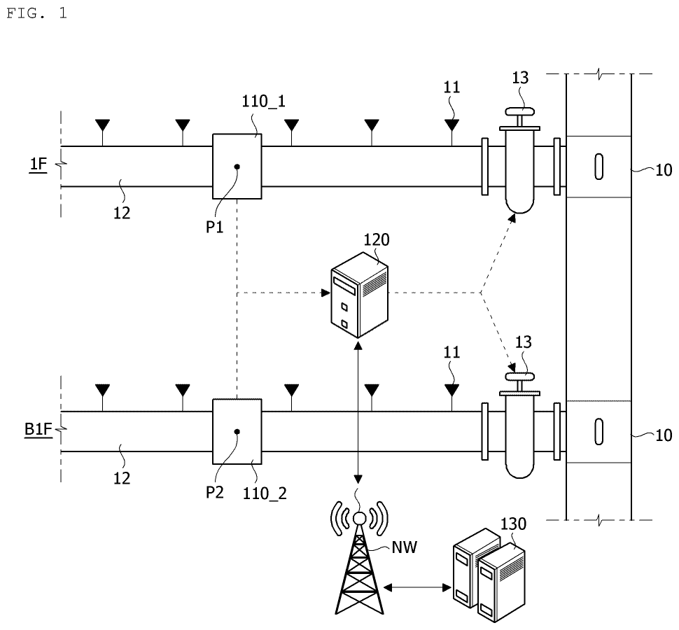

FIG. 1 exemplarily shows at least one sprinkler pipe to which a monitoring system is applied according to one embodiment.

Referring to FIG. 1, one or more sprinkler pipes to which the monitoring system according to one embodiment is applied may be implemented to receive water and an eco-friendly corrosion inhibitor from a tank 10 according to an opening/closing operation of one or more valves 13 connecting the tank 10 and one or more pipe sections 12 corresponding to a waterway.

For example, according to one embodiment, one or more pipe sections 12 for the at least one sprinkler pipe may be disposed for each floor (1F and B1F) of one building.

In this case, water (i.e., fire extinguishing water) and the eco-friendly corrosion inhibitor may be supplied from the tank 10 to one or more pipe sections 12 of each floor (1F and B1F) according to the opening/closing operation of one or more valves 13.

In addition, a plurality of sprinklers 11 provided on one or more pipe sections 12 may be implemented to spray water (i.e., fire extinguishing water) supplied through one or more pipe sections 12 to the surroundings.

In addition, the plurality of sprinklers 11 may be connected to an automatic distribution device (not shown) that stores the eco-friendly corrosion inhibitor through one or more pipe sections 12 and one or more valves 13.

For example, a plurality of composite sensor devices 110_1 and 110_2 may be coupled to installation positions P1 and P2 provided in advance, respectively, on one or more pipe sections 12 for the at least one sprinkler pipe of each floor (1F and B1F).

In this case, each of the plurality of composite sensor devices 110_1 and 110_2 may be implemented to transmit its own identification information and pipe state information measured at the corresponding installation positions P1 and P2 to a relay device 120 through a pre-established wireless (or wired) connection.

For example, the relay device 120 may control opening/closing of one or more valves 13 according to a command of an integrated control server 130.

In other words, the relay device 120 may be implemented to individually and completely open one or more valves 13, individually and completely close one or more valves 13, or individually adjust the degree of opening of one or more valves 13 according to a command of the integrated control server 130.

Meanwhile, although not shown in FIG. 1, the relay device 120 may be implemented to open a valve connected to the automatic distribution device (not shown) according to a command of the integrated control server 130 to mix (or inject) the eco-friendly corrosion inhibitor with (or into) water (i.e., fire extinguishing water) sprayed from the plurality of sprinklers 11.

For example, the relay device 120 may be understood as a gateway for supporting data transmission and reception between the plurality of composite sensor devices 110_1 and 110_2 and the integrated control server 130 based on a network NW.

In this case, the network NW may be pre-established based on at least one of a wired network or a wireless network based on LTE, 5G, or Wi-Fi communication protocols.

For example, the integrated control server 130 may be implemented based on a cloud server.

As an example, it may be determined by the integrated control server 130 that additional injection of the eco-friendly corrosion inhibitor toward a first pipe section 12 associated with a first installation position P1 is required according to the detection results of the plurality of composite sensor devices 110_1 and 110_2.

In this case, the integrated control server 130 may transmit, to the relay device 120, a control signal indicating opening of a valve located between the automatic distribution device (not shown) that stores an eco-friendly corrosion inhibitor and the first pipe section 12 associated with the first installation position P1.

Subsequently, the relay device 120 may be implemented such that the eco-friendly corrosion inhibitor is injected onto the first pipe section 12 associated with a specific position P1 by controlling the valve located between the automatic distribution device (not shown) and the first pipe section 12 associated with the first installation position P1 according to the control signal corresponding to an opening command.

In addition, the integrated control server 130 may detect aging of the pipe at the specific position P1 according to the detection results of the plurality of composite sensor devices 110_1 and 110_2.

In this case, the integrated control server 130 may be implemented to transmit pipe aging grade information and pipe replacement alarm information to an administrator terminal (not shown).

As an example, the pipe aging grade information may be understood as information output by an artificial intelligence learning model provided in advance by using one or more internal pressure values associated with pipe aging as an input.

In this case, the artificial intelligence learning model provided in advance may be associated with a support vector machine (SVM) algorithm.

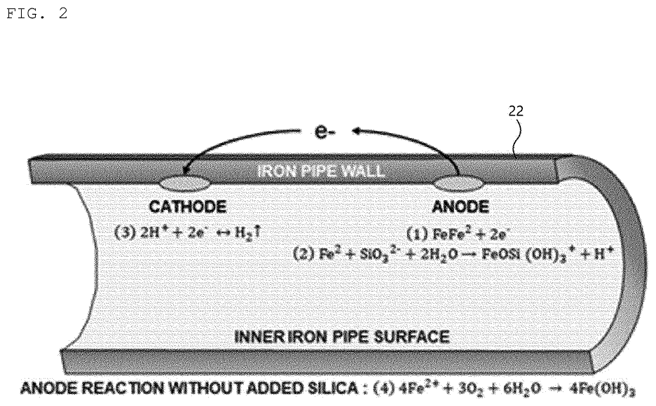

FIG. 2 shows a conceptual diagram for an eco-friendly corrosion inhibitor injected into the at least one sprinkler pipe according to one embodiment.

Referring to FIGS. 1 and 2, one or more pipe sections 22 of FIG. 2 may correspond to one or more pipe sections 12 for the at least one sprinkler pipe of each floor (1F and B1F) of FIG. 1.

One or more pipe sections 22 of FIG. 2 may include an eco-friendly corrosion inhibitor according to one embodiment.

For example, the eco-friendly corrosion inhibitor included in one or more pipe sections 22 of FIG. 2 may be a silicate-based corrosion inhibitor.

Specifically, a cathodic monomer (SiO₃²⁻), which is a main constituent factor of the silicate-based corrosion inhibitor, reacts with cations (Cu²⁺) while being generated by an oxidation reaction in an anode area of an inner surface of a copper pipe to form a protective monomolecular film (CuO·Si(OH)³⁺), thereby suppressing the oxidation reaction in the anode area.

In addition, when a homogenous monomolecular film is formed in the anode area, the cathodic monomer (SiO₃²⁻) in the corrosion inhibitor forms a highly insulating anion film (SiO₃²⁻film) to effectively block the oxidation reaction of the anode area.

As an example, the method principle of the silicate-based corrosion inhibitor according to one embodiment is as shown in

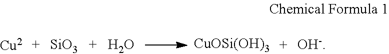

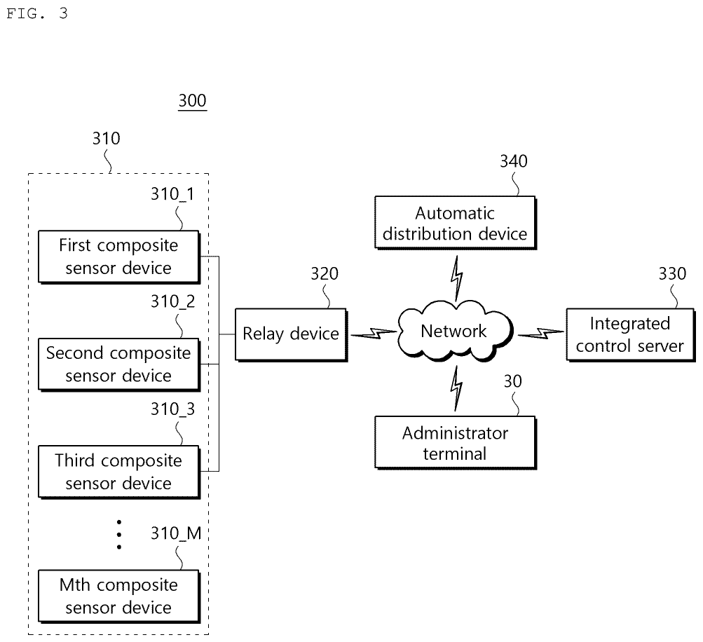

FIG. 3 shows a block diagram of the monitoring system for the at least one sprinkler pipe according to one embodiment.

Referring to FIGS. 1 to 3, a monitoring system 100 for the at least one sprinkler pipe according to one embodiment may include a plurality of composite sensor devices 310, a relay device 320, an integrated control server 330, and an automatic distribution device 340.

The plurality of composite sensor devices 310 of FIG. 3 may be coupled to a plurality of predetermined installation positions (e.g., P1 and P2 of FIG. 1) on one or more pipe sections (e.g., 12 of FIG. 1) for sprinkler pipe provided for each floor (e.g., 1F and B1F of FIG. 1) of FIG. 1 (or for each section).

For example, each of the plurality of composite sensor devices 310 may be implemented to generate pipe state information and identification information measured at its own installation position (e.g., P1 and P2 of FIG. 1).

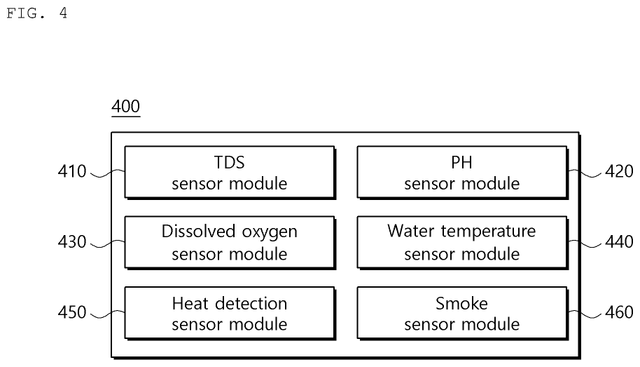

As an example, the pipe state information may correspond to data measured by a plurality of sensor modules included in the composite sensor device 310, and the plurality of sensor modules will be described in more detail with reference to FIG. 4 to be described later.

The relay device 320 of FIG. 3 may control the plurality of pipe state information and identification information received from the plurality of composite sensor devices 310 such that the plurality of pipe state information and identification information are transmitted to the integrated control server 330 through the network NW.

In addition, the relay device 320 may control the opening/closing operation of the valve (e.g., 13 of FIG. 1) on one or more pipe sections 12 for the at least one sprinkler pipe of each floor (e.g., 1F and B1F of FIG. 1) according to the control signal received from the integrated control server 330.

The integrated control server 330 of FIG. 3 may perform a pH abnormality detection function and an aging detection function for the at least one sprinkler pipe of each floor (e.g., 1F and B1F of FIG. 1) based on the plurality of pipe state information and the plurality of identification information received from the plurality of composite sensor devices 310.

As an example, the integrated control server 330 may be implemented based on a cloud server and interwork with an administrator terminal 30.

The automatic distribution device 340 of FIG. 3 is a component for storing the eco-friendly corrosion inhibitor of the present specification, and may be implemented to additionally inject the eco-friendly corrosion inhibitor into a specific position of the at least one sprinkler pipe provided for each floor (e.g., 1F and B1F of FIG. 1) under the control of the integrated control server 330.

FIG. 4 shows a block diagram of a composite sensor device according to one embodiment.

Referring to FIGS. 1 to 4, a composite sensor device 400 of FIG. 4 may correspond to any one of a plurality of composite sensor devices 310_1 to 310_M of FIG. 3.

For example, the composite sensor device 400 may include a TDS sensor module 410, a pH sensor module 420, a dissolved oxygen sensor module 430, a water temperature sensor module 440, a heat detection sensor module 450, and a smoke sensor module 460.

As an example, the total dissolved solids (TDS) sensor module 410 may be a component that measures the total amount of ions dissolved in water in units of mg/L or ppm.

In this case, the TDS sensor module 410 may generate sensing data according to the measured amount of metal ions such as calcium and magnesium of the fire extinguishing water filled in the pipe associated with an installation position where the composite sensor device 400 is installed.

As an example, the pH sensor module 420 may be a component that measures acidity and alkalinity of ions dissolved in water with a number between 0 and 14.

In this case, the pH sensor module 420 may generate sensing data (i.e., a pH measurement value) according to the measured ratio of hydrogen ions and hydroxide ions of the fire extinguishing water filled in the pipe associated with the installation position where the composite sensor device 400 is installed.

As an example, the dissolved oxygen sensor module 430 may be a component that measures the amount of oxygen dissolved in the fire extinguishing water filled in the pipe associated with the installation position where the composite sensor device 400 is installed.

In this case, the amount of oxygen, which is dissolved in the fire extinguishing water filled in the pipe of the sprinkler by the dissolved oxygen sensor module 430, may be associated with a hole generated in a surface of the pipe.

According to one embodiment, the composite sensor device 400 may be implemented to involve sensing data (i.e., a pH measurement value) measured by the pH sensor module 420 in the pipe state information to transmit the pipe state information to the integrated control server (e.g., 330 of FIG. 3).

According to one embodiment, the composite sensor device 400 may be implemented to involve information obtained by performing data processing on a sensing data set that is obtained from the TDS sensor module 410, the pH sensor module 420, and the dissolved oxygen sensor module 430 in the pipe state information to transmit the information to the integrated control server (e.g., 330 of FIG. 3) in order to generate more accurate pH state information of the fire extinguishing water filled in the pipe of the sprinkler.

As an example, the water temperature sensor module 440 may be a component for measuring a water temperature of the fire extinguishing water filled in the pipe of the sprinkler.

For reference, the water temperature sensor module 440 may be implemented to satisfy all of the IPC standards because both a detection circuit and a PCB need to be disposed inside the pipe in order to measure the water temperature.

In this case, the water temperature sensor module 440 may be integrally manufactured with a water pressure sensor (not shown). In addition, when the fire extinguishing water filled due to a decrease in an ambient temperature freezes, the pipe may be prevented from rupturing through the sensing data measured by the water temperature sensor module 440, or a decrease in a fire extinguishing effect of water (i.e., fire extinguishing water) may be prevented in advance due to an increase in the water temperature.

In this case, the composite sensor device 400 measured by the water pressure sensor (not shown) may generate sensing data (i.e., internal pressure value) according to an internal pressure of the fire extinguishing water filled in the pipe associated with the installation position.

According to one embodiment, the water temperature sensor module 440 and the water pressure sensor (not shown) may be understood as components for measuring the degree of aging of the pipe associated with the installation position where the composite sensor device 400 is installed.

As an example, the heat detection sensor module 450 may be a component that measures a temperature of the pipe associated with the installation position where the composite sensor device 400 is installed.

In this case, when the temperature of the pipe measured by the heat detection sensor module 450 exceeds a preset threshold value, the heat detection sensor module 450 may generate an alarm signal for notifying the occurrence of fire.

As an example, the smoke sensor module 460 may be a component that measures the amount of smoke around the pipe associated with the installation position where the composite sensor device 400 of the sprinkler is installed.

In this case, when the amount of smoke around the pipe, which is measured by the smoke sensor module 460, exceeds a preset threshold value, the smoke sensor module 460 may generate an alarm signal for notifying the occurrence of fire.

According to one embodiment, a plurality of sensor modules 410 to 460 included in the composite sensor device 400 may be disposed in one housing or may be disposed at an independent position with respect to the pipe of the sprinkler.

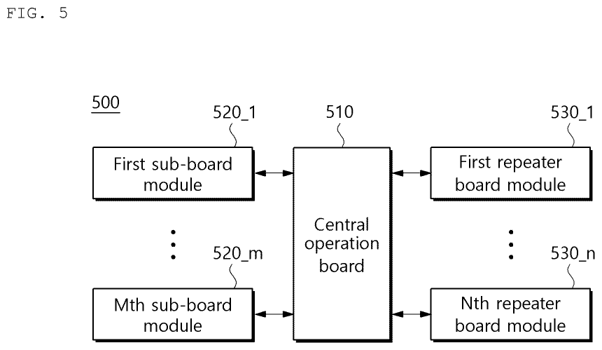

FIG. 5 shows a block diagram for a relay device according to one embodiment.

Referring to FIGS. 1 to 5, a relay device 500 of FIG. 5 may correspond to the relay device 320 of FIG. 3.

The relay device 500 of FIG. 5 may include a central operation board 510, a plurality of sub-board modules 520_1 to 520_m, and a plurality of repeater board modules 530_1 to 530_n.

For example, the central operation module 510 may be a component that controls an overall operation of the relay device 500. In this case, the central operation board 510 may be implemented based on a micro controller.

The first to M^{th} sub-board modules 520_1 to 520_m (where, m is a natural number) of FIG. 5 may be understood as a type of a substrate jig that serves to fix a PCB substrate inside the housing of the relay device 500.

In this case, the first to M^{th} sub-board modules 520_1 to 520_m may be inserted into an edge of the PCB substrate to not only accurately maintain a position of the PCB substrate, but also serve to prevent damage or malfunction due to vibration.

For example, the first to M^{th} sub-board modules 520_1 to 520_m may be implemented to interwork with at least one sensor module (e.g., 410, 420, 430, or 440 of FIG. 4) associated with pH detection and aging detection among the plurality of sensor modules included in the above-described composite sensor device (e.g., 400 of FIG. 4).

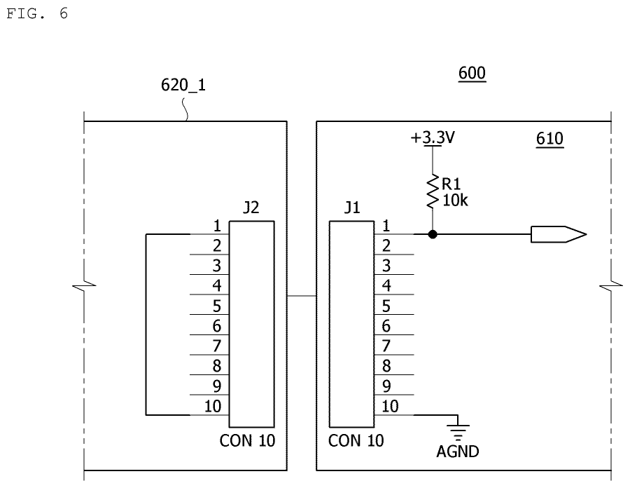

In addition, a cable loop circuit of FIG. 6 to be described later may be individually applied between the first to M^{th} sub-board modules 520_1 to 520_m and at least one sensor module (e.g., 410, 420, or 430 of FIG. 4) associated with pH detection.

Similarly, the cable loop circuit of FIG. 6 to be described later may be individually applied between the first to M^{th} sub-board modules 520_1 to 520_m and at least one sensor module (e.g., 430 of FIG. 4) associated with detection of pipe aging.

As an example, the cable loop circuit of FIG. 6 may be applied between the first sub-board module 520_1 and the TDS sensor module (e.g., 410 of FIG. 4).

As an example, the cable loop circuit of FIG. 6 may be applied between the second sub-board module 520_2 and the pH sensor module (e.g., 420 of FIG. 4).

As an example, the cable loop circuit of FIG. 6 may be applied between the third sub-board module 520_3 and the dissolved oxygen sensor module (e.g., 430 of FIG. 4).

As an example, the cable loop circuit of FIG. 6 may be applied between the fourth sub-board module 520_4 and the water temperature sensor module (e.g., 440 of FIG. 4).

The first to N^{th} repeater board modules 530_1 to 530_n (where, n is a natural number) of FIG. 5 may be implemented to interwork with at least one sensor module (e.g., 450 or 460 of FIG. 4) associated with fire detection among the plurality of sensor modules included in the composite sensor device (e.g., 400 of FIG. 4) described above.

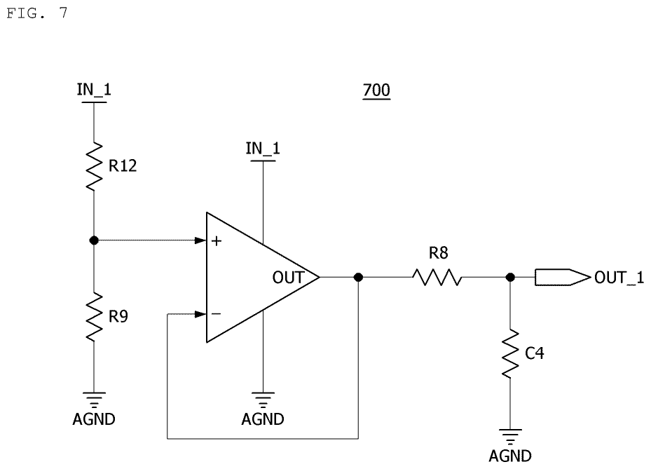

In addition, an inspection circuit of FIG. 7 to be described later may be individually applied between the first to N^{th} repeater board modules 530_1 to 530_n and at least one sensor module (e.g., 450 or 460 of FIG. 4) associated with fire detection.

As an example, the cable loop circuit of FIG. 7 may be applied between the first repeater board module 530_1 and the heat detection sensor module (e.g., 450 of FIG. 4).

As an example, the cable loop circuit of FIG. 7 may be applied between the second repeater board module 530_2 and the smoke sensor module (e.g., 460 of FIG. 4).

FIG. 6 is an exemplary diagram of a cable loop circuit applied to the monitoring system for the at least one sprinkler pipe according to one embodiment.

Referring to FIGS. 1 to 6, it will be understood that reliability of the operation of the monitoring system for the at least one sprinkler pipe according to one embodiment may be improved through an application of a structure of a cable loop circuit 600 of FIG. 6.

For example, the structure of the cable loop circuit 600 of FIG. 6 may be applied between the central operation board 610 and a first sub-board module 620_1 to ensure a normal operation of the TDS sensor module (e.g., 410 of FIG. 4).

For another example, although not shown in FIG. 6, the structure of the cable loop circuit 600 may be applied between the central operation board (e.g., 510 of FIG. 5) and the second sub-board module (e.g., 520_2 of FIG. 5) to ensure a normal operation of the pH sensor module (e.g., 420 of FIG. 4).

For still another example, although not shown in FIG. 6, the structure of the cable loop circuit 600 may be applied between the central operation board (e.g., 510 of FIG. 5) and the third sub-board module (e.g., 520_3 of FIG. 5) to ensure a normal operation of the dissolved oxygen sensor module (e.g., 430 of FIG. 4).

For still another example, although not shown in FIG. 6, the structure of the cable loop circuit 600 may be applied between the central operation board (e.g., 510 of FIG. 5) and the fourth sub-board module (e.g., 520_4 of FIG. 5) to ensure a normal operation of the water temperature sensor module (e.g., 440 of FIG. 4).

Meanwhile, the cable loop circuit 600 according to one embodiment is not limited to the structure of FIG. 6, and any one of various conventionally known structures may be applied thereto.

FIG. 7 is an exemplary diagram of an inspection circuit applied to the monitoring system for the at least one sprinkler pipe according to one embodiment.

Referring to FIGS. 1 to 7, when a first input signal IN 1 is applied to an inspection circuit 700 of FIG. 7, the reliability of the operation of at least one sensor module (e.g., 450 or 460 of FIG. 4) associated with fire detection may be ensured by determining proper output of a first output signal OUT 1.

For example, the inspection circuit 700 of FIG. 7 may correspond to a voltage of +3.3 V, +5 V, and +24 V.

For example, although not shown in FIG. 7, the structure of the inspection circuit 700 may be applied bi-directionally between the central operation board (e.g., 510 of FIG. 5) and the first repeater board module (e.g., 530_1 of FIG. 5) to ensure a normal operation of the heat detection sensor module (e.g., 450 of FIG. 4).

For another example, although not shown in FIG. 7, the structure of the inspection circuit 700 may be applied bi-directionally between the central operation board (e.g., 510 of FIG. 5) and the second repeater board module (e.g., 530_2 of FIG. 5) to ensure a normal operation of the smoke sensor module (e.g., 460 of FIG. 4).

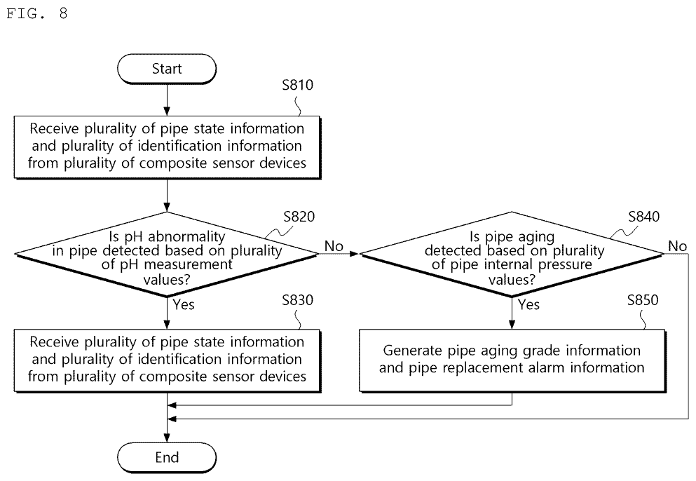

FIG. 8 is a flowchart related to an operation method of the monitoring system for the at least one sprinkler pipe according to one embodiment.

For clear and concise understanding of one embodiment, a normal operation state in which a fire is not detected by some sensor modules (e.g., 450 and 460 of FIG. 4) in charge of a fire detection function of the plurality of composite sensor devices (e.g., 310_1 to 310_M of FIG. 3) installed in the at least one sprinkler pipe is assumed.

Referring to FIGS. 1 to 8, in step S810, the monitoring system (e.g., 300 of FIG. 3) for the at least one sprinkler pipe according to one embodiment may receive the plurality of pipe state information and the plurality of identification information measured by the plurality of composite sensor devices (e.g., 310_1 to 310_M of FIG. 3).

For example, the plurality of pipe state information may include a pH measurement value and an internal pressure value, which are individually measured at a position where the plurality of composite sensor devices (e.g., 310_1 to 310_M of FIG. 3) are installed.

For example, the plurality of identification information may be information for individually identifying the plurality of composite sensor devices (e.g., 310_1 to 310_M of FIG. 3).

As an example, the relay device (e.g., 320 of FIG. 3) may be installed at the first installation position (e.g., P1 of FIG. 1) of the at least one sprinkler pipe, and may receive, from the first composite sensor device (e.g., 310_1 of FIG. 3), first pipe state information for the first pipe section (e.g., 12 of FIG. 1) associated with the first installation position (e.g., P1 of FIG. 1) together with first identification information indicating the first composite sensor device (e.g., 310_1 of FIG. 3).

In this case, the first pipe state information may include a first pH measurement value and a first internal pressure value measured at the first installation position (e.g., P1 of FIG. 1).

Similarly, the relay device (e.g., 320 of FIG. 3) may be installed at the second installation position (e.g., P2 of FIG. 1) of the at least one sprinkler pipe, and may receive, from the second composite sensor device (e.g., 310_2 of FIG. 3), second pipe state information for the second pipe section (e.g., 12 of FIG. 1) associated with the second installation position (e.g., P2 of FIG. 1) together with second identification information indicating the second composite sensor device (e.g., 310_2 of FIG. 3).

In this case, the first pipe state information may include a second pH measurement value and a second internal pressure value measured at the second installation position (e.g., P2 of FIG. 1).

Subsequently, the integrated control server (e.g., 330 of FIG. 3) may receive the plurality of pipe state information and the plurality of identification information from the relay device (e.g., 320 of FIG. 3) through the pre-established network (e.g., NW of FIG. 3).

In step S820, the monitoring system (e.g., 300 of FIG. 3) for the at least one sprinkler pipe according to one embodiment may detect a pH abnormality in the at least one sprinkler pipe based on a plurality of pH measurement values included in the plurality of pipe state information.

For example, the integrated control server (e.g., 330 of FIG. 3) may determine that a first pH value obtained from the first composite sensor device (e.g., 310_1 of FIG. 3) installed at the first installation position (e.g., P1 of FIG. 1) indicated according to the first identification information is out of a preset first threshold range.

In this case, the integrated control server (e.g., 330 of FIG. 3) may determine that the pH abnormality has occurred in the pipe section associated with the corresponding position (e.g., P1 of FIG. 1), and the process proceeds to step S830.

For another example, the integrated control server (e.g., 330 of FIG. 3) may determine that the first pH value obtained from the first composite sensor device (e.g., 310_1 of FIG. 3) installed at the specific position (e.g., P1 of FIG. 1) of the at least one sprinkler pipe is within the preset first threshold range.

In this case, the integrated control server (e.g., 330 of FIG. 3) may determine that the pH abnormality has not occurred in the pipe section associated with the corresponding position (e.g., P1 of FIG. 1) according to the first identification information, and the process proceeds to step S840.

In step S830, the monitoring system (e.g., 300 of FIG. 3) for the at least one sprinkler pipe according to one embodiment may transmit, to the automatic distribution device (e.g., 340 of FIG. 3), a control signal for injecting the eco-friendly corrosion inhibitor into at least one pipe section (e.g., 12 of FIG. 1) associated with at least one position (e.g., P1 of FIG. 1) where the pH abnormality is detected.

In other words, when the control signal is received from the integrated control server (e.g., 330 of FIG. 3) to the automatic distribution device (e.g., 340 of FIG. 3) through the pre-established network (e.g., NW of FIG. 3), the automatic distribution device (e.g., 340 of FIG. 3) may control the eco-friendly corrosion inhibitor to be injected into the pipe section associated with the position (e.g., P1 of FIG. 1) where the pH abnormality is detected.

In step S840, the monitoring system (e.g., 300 of FIG. 3) for the at least one sprinkler pipe according to one embodiment may detect pipe aging of the sprinkler based on a plurality of internal pressure values included in the plurality of pipe state information.

For example, the integrated control server (e.g., 330 of FIG. 3) may determine that a first internal pressure value obtained from the first composite sensor device (e.g., 310_1 of FIG. 3) indicated according to the first identification information is out of a preset second threshold range.

In this case, the integrated control server (e.g., 330 of FIG. 3) may determine that an aging phenomenon has occurred in the pipe section associated with the corresponding position (e.g., P1 of FIG. 1), and the process proceeds to step S850.

In step S850, the monitoring system (e.g., 300 of FIG. 3) for the at least one sprinkler pipe according to one embodiment may generate pipe aging grade information for one or more installation positions (e.g., P1 of FIG. 1) where pipe aging is detected.

For example, the pipe aging grade information may be understood as information output by an artificial intelligence learning model provided in advance by using one or more internal pressure values associated with pipe aging as an input.

In this case, the artificial intelligence learning model provided in advance may be associated with an SVM algorithm.

In addition, the monitoring system (e.g., 300 of FIG. 3) for the at least one sprinkler pipe according to one embodiment may generate pipe replacement alarm information for one or more installation positions (e.g., P1 of FIG. 1) where pipe aging is detected.

In this case, the pipe replacement alarm information may be implemented to be transmitted from the integrated control server (e.g., 330 of FIG. 3) to the administrator terminal (e.g., 30 of FIG. 3) via the pre-established network (e.g., NW of FIG. 3).

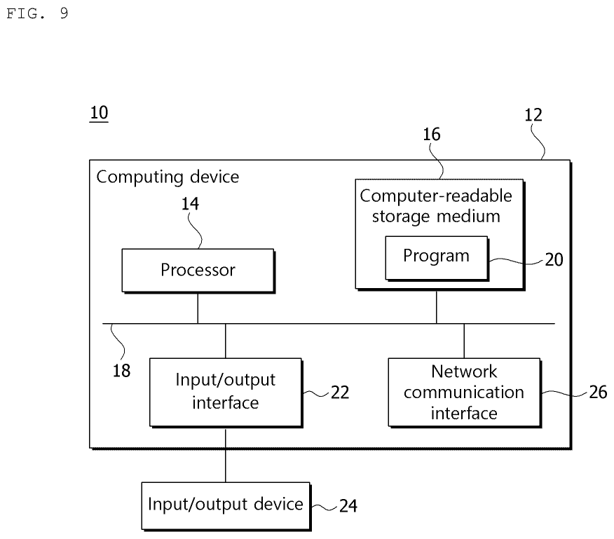

FIG. 9 is a block diagram for exemplarily explaining a computing environment including a computing device suitable for use in an exemplary embodiment.

Referring to FIGS. 1 to 9, in the illustrated embodiment, each component may have different functions and capabilities in addition to those described below, and may include additional components in addition to those described later.

The illustrated computing environment 10 includes a computing device 12. According to one embodiment, the computing device 12 may correspond to the monitoring system (e.g., 300 of FIG. 3) for the at least one sprinkler pipe described in the present specification.

The computing device 12 includes at least one processor 14, a computer-readable storage medium 16, and a communication bus 18. The processor 14 may cause the computing device 12 to operate in accordance with the above-described exemplary embodiments.

For example, the processor 14 may execute one or more programs stored in the computer-readable storage medium 16. The one or more programs may include one or more computer-executable instructions, and the computer-executable instructions, when executed by the processor 14, may be configured to cause the computing device 12 to perform operations according to the exemplary embodiment.

The computer-readable storage medium 16 is configured to store computer-executable instructions or program code, program data, and/or other suitable forms of information. The program 20 stored in the computer-readable storage medium 16 includes a set of instructions executable by the processor 14.

According to one embodiment, the computer-readable storage medium 16 may be a memory (volatile memory such as random access memory, non-volatile memory, or a suitable combination thereof), one or more magnetic disk storage devices, optical disk storage devices, flash memory devices, other forms of storage medium that may be accessed by the computing device 12 and store desired information, or a suitable combination thereof.

The communication bus 18 interconnects various other components of the computing device 12, including the processor 14 and the computer-readable storage medium 16.

The computing device 12 may also include one or more input/output interfaces 22 and one or more network communication interfaces 26 that provide interfaces for one or more input/output devices 24. The input/output interface 22 and the network communication interface 26 are connected to the communication bus 18.

The input/output device 24 may be connected to other components of the computing device 12 through the input/output interface 22. The exemplary input/output device 24 may include a pointing device (a mouse, a trackpad, or the like), a keyboard, a touch input device (a touch pad, a touch screen, or the like), an input device such as a voice or sound input device, various types of sensor devices, and/or a photographing device, and/or an output device such as a display device, a printer, a speaker, and/or a network card.

The exemplary input/output device 24 may be included in the computing device 12 as one component constituting the computing device 12, or may be a separate device distinct from the computing device 12 and may be connected to the monitoring system (e.g., 300 of FIG. 3) for the at least one sprinkler pipe based on the pre-established communication protocol.

In the detailed description of the present specification, specific embodiments have been described, but various modifications are possible without departing from the scope of the present specification. Therefore, the scope of the present specification should not be limited to the above-described embodiments, but should be determined not only by the claims to be described later, but also by those equivalent to the claims of the present invention.

1. An operation method for a monitoring system for at least one sprinkler pipe, the operation method comprising:
receiving, from a first composite sensor device, first identification information indicating the first composite sensor device associated with a first installation position and first pipe state information measured by the first composite sensor device,
wherein the first pipe state information includes a first pH measurement value and a first internal pressure value for a first pipe section associated with the first installation position;
receiving, from a second composite sensor device, second identification information indicating the second composite sensor device associated with a second installation position and second pipe state information measured by the second composite sensor device,
wherein the second pipe state information includes a second pH measurement value and a second internal pressure value for a second pipe section associated with the second installation position;
detecting a pH abnormality for the at least one sprinkler pipe based on the first pH measurement value and the second pH measurement value; and
transmitting, to an automatic distribution device, a control signal indicating injection of an eco-friendly corrosion inhibitor into at least one pipe section in which the pH abnormality is detected, when it is determined that at least one pH value is out of a preset first threshold range based on the first pH measurement value and the second pH measurement value.

2. The operation method of claim 1, wherein the eco-friendly corrosion inhibitor corresponds to a silicate-based corrosion inhibitor, and
the at least one pipe section is determined based on the first identification information and the second identification information.

3. The operation method of claim 1, further comprising detecting pipe aging for the at least one sprinkler pipe based on the first internal pressure value and the second internal pressure value, when it is determined that the at least one pH value is not out of the first threshold range.

4. The operation method of claim 3, further comprising generating replacement alarm information about at least one of the first and second pipe sections, in which aging is detected, when it is determined that at least one internal pressure value is out of a preset second threshold range based on the first internal pressure value and the second internal pressure value.

5. A monitoring system for at least one sprinkler pipe, the monitoring system comprising:
a plurality of composite sensor devices associated with a plurality of installation positions of the at least one sprinkler pipe, respectively;
at least one relay device configured to individually receive a plurality of pipe state information and a plurality of identification information from the plurality of composite sensor devices;
an automatic distribution device configured to store and supply an eco-friendly corrosion inhibitor; and
an integrated control server configured to interwork with the at least one relay device and the automatic distribution device through a pre-established network,
wherein the integrated control server is configured to: detect a pH abnormality for the at least one sprinkler pipe based on a plurality of pH measurement values included in the plurality of pipe state information; and transmit, to the automatic distribution device, a control signal indicating injection of the eco-friendly corrosion inhibitor into at least one pipe section, in which the pH abnormality is detected, when it is determined that at least one pH value is out of a preset first threshold range based on the plurality of pH measurement values.
